(19) United States
(12) Patent Application Publication
(10) Pub. No.: US 2012/0147351 A1
(43) Pub. Date: Jun. 14, 2012

(54) SPECTRAL PURITY FILTER, LITHOGRAPHIC APPARATUS, AND METHOD FOR MANUFACTURING A SPECTRAL PURITY FILTER

(75) Inventors: Martin Jacobus Johan Jak, Eindhoven (NL); Wouter Anthon Soer, Nijmegen (NL)

(73) Assignee: ASML Netherlands B.V., Veldhoven (NL)

(21) Appl. No.: 13/391,095

(22) PCT Filed: Jul. 14, 2010
(86) PCT No.: PCT/EP2010/060156

§ 371 Date: Feb. 17, 2012

Related U.S. Application Data
(60) Provisional application No. 61/235,829, filed on Aug. 21, 2009.

(51) Int. Cl. G03B 27/72; B29D 11/00; G02B 5/20

(52) U.S. Cl. 355/71; 359/350; 216/24

(57) ABSTRACT

A transmissive spectral purity filter is configured to transmit extreme ultraviolet radiation (λ<20 nm). The filter comprises a grid-like structure comprising a plurality of microscopic apertures fabricated in a carrier material such as silicon. The grid-like structure in at least part of its area is formed so as to have, within an expected range of operating conditions, a negative Poisson's ratio. By forming the grid of a material that likes to expand or contract simultaneously in orthogonal directions, the management of differential thermal expansion is improved. Various geometries are possible to achieve a negative Poisson's ratio. The aperture geometry may that of a re-entrant polygon or re-entrant shape having curved sides. Examples include a so-called re-entrant or auxetic honeycomb, in which each aperture is hexagonal, as in the regular honeycomb, but the form is a re-entrant hexagon rather than a regular hexagon.

### CROSS-REFERENCE TO RELATED APPLICATIONS

This application claims the benefit of U.S. provisional application 61/235,829 which was filed on 21 Aug. 2009, and which is incorporated herein in its entirety by reference.

### FIELD

The present invention relates to spectral purity filters, lithographic apparatus including such spectral purity filters, and methods for manufacturing spectral purity filters. The invention further relates to microporous or grid type optical components generally, of which purity filters for EUV radiation are one example.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of one or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include steppers, in which each target portion is irradiated by exposing an entire pattern onto the target portion at one time, and scanners, in which each target portion is irradiated by scanning the pattern through a radiation beam in a given direction (the “scanning” direction) while synchronously scanning the substrate parallel or anti-parallel to this direction. It is also possible to transfer the pattern from the patterning device to the substrate by imprinting the pattern onto the substrate.

A key factor limiting pattern printing is the wavelength λ of the radiation used. In order to be able to project ever smaller structures onto substrates, it has been proposed to use extreme ultraviolet (EUV) radiation which is electromagnetic radiation having a wavelength within the range of 10-20 nm, for example within the range of 13-14 nm. It has further been proposed that EUV radiation with a wavelength of less than 10 nm could be used, for example within the range of 5-10 nm such as 6.7 nm or 6.8 nm. Such EUV radiation is sometimes termed soft x-ray. Possible sources include, for example, laser-produced plasma sources, discharge-produced plasma sources, or synchrotron radiation from electron storage rings.

EUV sources based on a Sn plasma do not only emit the desired in-band EUV radiation but also out-of-band radiation, most notably in the deep UV (DUV) range (100-400 nm). Moreover, in the case of laser-produced plasma (LPP) EUV sources, the infrared radiation from the laser, usually at 10.6 μm, presents a significant amount of unwanted radiation. Since the optics of the EUV lithographic system generally have substantial reflectivity at these wavelengths, the unwanted radiation propagates into the lithography tool with significant power if no measures are taken.

In a lithographic apparatus, out-of-band radiation should be minimized for several reasons. Firstly, resist is sensitive to out-of-band wavelengths, and thus the image quality may be deteriorated. Secondly, unwanted radiation, especially the 10.6 μm radiation in LPP sources, leads to unwanted heating of the mask, wafer and optics. In order to bring unwanted radiation within specified limits, spectral purity filters (SPFs) are being developed.

Spectral purity filters can be either reflective or transmissive for EUV radiation. Implementation of a reflective SPF involves modification of an existing minor or insertion of an additional reflective element. A transmissive SPF is typically placed between the collector and the illuminator and, in principle at least, does not affect the radiation path. This may have an advantage because it results in flexibility and compatibility with other SPFs.

Grid SPFs form a class of transmissive SPFs that may be used when the unwanted radiation has a much larger wavelength than the EUV radiation, for example in the case of 10.6 μm radiation in LPP sources. Grid SPFs contain apertures with a size of the order of the wavelength to be suppressed. The suppression mechanism may vary among different types of grid SPFs as described in the prior art and detailed embodiments further in this document. Since the wavelength of EUV radiation (13.5 nm) is much smaller than the size of the apertures (typically >3 μm), EUV radiation is transmitted through the apertures without substantial diffraction.

Several prior art spectral purity filters (SPFs) rely on a grid with micron-sized apertures to suppress unwanted radiation. U.S. Patent Application Publication 2006/0146413 discloses a spectral purity filter (SPF) comprising an array of apertures with diameters up to 20 μm. Depending on the size of the apertures compared to the radiation wavelength, the SPF may suppress unwanted radiation by different mechanisms. If the aperture size is smaller than approximately half of the (unwanted) wavelength, the SPF reflects virtually all radiation of this wavelength. If the aperture size is larger, but still of the order of the wavelength, the radiation is at least partially diffracted and may be absorbed in a waveguide inside the aperture.

The approximate material parameters and specifications for these SPFs are known. However, manufacturing is not straightforward at these specifications. The most challenging specifications are: apertures of typically 4 μm in diameter; a grid thickness of typically 5-10 μm; very thin (typically <1 μm) and parallel (non-tapered) walls between the apertures to ensure maximal EUV transmission.

Silicon has emerged as a promising material for the manufacture of such grids, using the photolithographic patterning and anisotropic etching processes that are well-understood from semiconductor manufacturing. For deep apertures with a well-controlled cross-section, deep reactive ion etching (DRIE) has been found promising, although of course problems remain. US application No. 61/193,769 filed on 22 Dec. 2008 discloses various methods for manufacture which are applicable in the present invention. The contents of that application are incorporated herein by reference.

Whether in a silicon based grid-type spectral purity filter or one of other material, it has been found that a hexagonal grid with the proper spacing reflects infrared radiation from the source, while transmitting EUV. As is well-known from the natural phenomenon of the honeycomb, a hexagonal grid optimizes strength and use of material compared with other polygonal forms. Similarly, the regular honeycomb structure optimizes openness and EUV transmission.

When the grid is illuminated by the source it should reflect infrared and transmit EUV. However, a small fraction (say, 10-20%) of both types of radiation will be absorbed. Given the very high power levels, which may be >1000 W, this may result in significant heating of the grid. Since thermal conduction is poor due to the very small thickness of the grid, variations in power density across the beam also give rise to temperature gradients over the grid area, and there will also be temperature differences between grid and the surrounding frame. Non-uniform temperatures will result in non-uniform thermal expansions and hence in stress and/or tension in the grid.

Stresses and/or tension can also arise in applications in which the grid part is subject to deformation after manufacture. Deformation may arise as an undesired consequence of its operating environment, or as a deliberate feature.

The inventors have recognized that the rigid compact shape of the honeycomb also implies that it is not easy for the structure to accommodate local expansions. Furthermore, like most materials, it has a positive Poisson's ratio, meaning that if it is stretched in one direction, it will contract in the other direction (if that is not counteracted by another force). Given the symmetry of typical applications it can be expected that forces in the grid will be acting in both directions simultaneously. Also, when deformed, the regular honeycomb structure tends to undergo saddle-shaped (anti-clastic) bending, like a potato crisp, rather than bulging uniformly.

To provide a grid and supporting structure which can manage these forces without damage implies more material should be deployed to strengthen the structure, which is contrary to the desired openness.

### SUMMARY

It is an aspect of the present invention to provide a microscopic grid component such as an EUV spectral purity filter which is effective and easy to manufacture, and in which forces caused by thermal expansion and deformation can be better managed. The inventors have recognized that alternative grid geometries can be applied, having a smaller or even a negative Poisson's ratio, to provide a better compromise between openness and strength in the presence of external forces and/or differential expansion within the grid. The invention, defined in the appended claims, applies so-called auxetic structures in place of a regular honeycomb, at least for a portion of the grid. Such structures have been noted and investigated by a few researchers, notably in: R. Lakes, Science 235, p 1038 (1987); R. S. Lakes, ASME Journal of Mechanical Design, 115, p 696 (1993); D. Prall, R. S. Lakes, Int. J. of Mechanical Sciences, 39, 305-314, (1996); F. C Smith and F. Scarpa, IEE Proc.-Sci. Meas. Technol., 151, p. 9 (2004).

According to an aspect, there is provided a spectral purity filter configured to transmit extreme ultraviolet radiation, the spectral purity filter comprising a substantially planar filter part comprising an array of apertures formed between walls of a grid material, such as silicon, the apertures extending from a front surface to a rear surface of the filter part to transmit the extreme ultraviolet radiation incident on said front surface while suppressing transmission of a second type of radiation, wherein the apertures in an auxetic portion of said filter part are shaped and arrayed so as to confer a negative Poisson's ratio on the auxetic portion. A thickness of the filter part may be less than 20 μm. The diameter of aperture in at least one portion of the filter part may be greater than 2 μm. The diameter of each aperture in at least one portion of the filter part may be in the range of 2-10 μm. The apertures in at least one portion of the filter part may have a period in the range of about 2 to 6 μm.

According to an embodiment of the present invention, there is provided a spectral purity filter for extreme ultraviolet radiation (λ<20 nm), the filter comprising a grid-like structure comprising a plurality of microscopic apertures fabricated in a carrier material such as silicon. The grid-like structure in at least part of its area is formed so as to have, within an expected range of operating conditions, a negative Poisson's ratio. By forming the grid of a material that likes to expand or contract simultaneously in orthogonal directions, the management of thermally-induced forces becomes much easier.

The grid-like structure for example comprises a substantially planar filter part having a plurality of apertures, each defined by a side wall extending fully or substantially from a front surface to a rear surface of the filter part. In at least part of the area of the planar filter, the geometry and tessellation of the apertures is adapted to provide the negative Poisson's ratio.

Various geometries are possible to achieve a negative Poisson's ratio. In one class of embodiment, sections of sidewall around each aperture are capable of bending so as to decouple changes in the path length of a wall section from changes in the distance between the end points of that wall section. Such bending may be concentrated at defined hinge points between straight wall sections. Bending may also be distributed along an arcuate (curved) wall section, as an alternative or addition to providing defined hinge points.

Where straight wall sections are joined at vertices which include such hinge points, the aperture geometry may that of a re-entrant polygon. Examples include a so-called re-entrant or auxetic honeycomb, in which each aperture is hexagonal, as in the regular honeycomb, but the form is a re-entrant hexagon rather than a regular hexagon.

Regarding the grid structure as a tessellation of shaped apertures, the shapes of at least a subset of the apertures in the auxetic portion may be re-entrant shapes, that is shapes having at least one concave side. Examples include re-entrant polygons and re-entrant shapes having concave curved sides. A re-entrant polygon may have a plurality straight sides which meet at a corresponding plurality of vertices, the internal angles of the vertices being a mixture of acute angles and reflex angles. By hinge action at the vertices, the reflex angles can decrease while the acute angles increase, permitting the structure to expand in two dimensions.

The shape of all apertures in the auxetic portion may be uniform, or the grid may comprise a tessellation of two or more different shapes. Factors influencing the choice of geometry for an auxetic portion include the type of forces expected, as well as the desire for openness and uniformity in the grid. The filter part may comprise auxetic and non-auxetic portions. The filter part may comprise auxetic portions of different geometry. Different geometry includes possibly different shapes and/or different tessellations of the same shape. Different geometry includes also different angles, within the same basic shape. The character of the auxetic portion can be varied in zones or continuously by this means.

The auxetic portion may have a Poisson's ratio of approximately −1, for example in the range −0.8 to −1.0, either when resting at room temperature and/or over the expected operating conditions. The expected operating conditions may include a maximum local temperature of over 500 degrees Celsius over the gird, and a temperature difference of more than 100 degrees from a center to an edge of the filter part, and/or a temperature gradient of more than 20 degrees per centimeter.

The spectral purity filter may be of the transmissive type comprising a filter part having a plurality of apertures extending from a front to a rear surface of the filter part to transmit the extreme ultraviolet radiation while suppressing transmission of a second type of radiation. The dimensions of each aperture in the plane of the filter part may be greater than 2 μm, for example in the range 2-10 μm, or in the range 1.5-10 μm, or in the range 1.5-4 μm, or in the range 2-3 μm. That is much greater than the EUV wavelengths of interest, but comparable with the wavelengths of far infrared, for example, which are to be suppressed.

The spectral purity filter may include a filter part comprising silicon (Si) and having a thickness of about 10 μm, and a plurality of apertures in the filter part, each aperture being defined by a substantially perpendicular sidewall.

According to an embodiment of the present invention, there is provided a lithographic apparatus that includes a radiation source configured to generate radiation comprising extreme ultraviolet radiation, an illumination system configured to condition the radiation into a beam of radiation, and a support configured to support a patterning device. The patterning device is configured to pattern the beam of radiation. The apparatus also includes a projection system configured to project a patterned beam of radiation onto a target material, and a spectral purity filter configured to filter the extreme ultraviolet radiation from other radiation. The spectral purity filter comprises a grid-like structure of which at least a portion has a negative Poisson's ratio.

According to an embodiment of the present invention there is provided a method for manufacturing a transmissive spectral purity filter, the method comprising etching a plurality of apertures in a semiconductor or other carrier material substrate using an anisotropic etching process for form a grid-like filter part.

According to an embodiment of the present invention, anisotropic etching of the apertures is performed in a silicon substrate using deep reactive ion etching. The silicon substrate has a thickness of about 5 μm, and the apertures have diameters in the range 2-10 μm, for example about 2 μm to about 5 μm.

The invention is not limited in application to spectral purity filters, but may be applied in any optical component based on a microporous or grid-like element. Such elements may function for example as contaminant traps, electrodes or the like, through which a radiation beam passes and which is subject to differential heating. The invention further provides lithography apparatus including such elements, and methods of making such elements analogous to the manufacture of SPFs described herein.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts schematically a lithographic apparatus according to an embodiment of the invention;

FIG. 2 depicts the layout of a lithographic apparatus according to an embodiment of the present invention;

FIG. 3 is a partial front view of a spectral purity filter in accordance with an embodiment of the present invention;

FIG. 4 is a schematic detail of a grid part of regular honeycomb form in (a) plan view and (b) cross-section on line B-B′;

FIGS. 5A-5D depict a schematic overview of an example manufacturing process of a spectral purity filter in accordance with an embodiment of the invention;

FIG. 6 illustrates the geometry of a regular honeycomb grid in (a) relaxed and (b) stressed conditions;

FIG. 7 illustrates the geometry of a re-entrant honeycomb grid in (a) relaxed and (b) stressed conditions, as one example of an auxetic grid portion;

FIG. 8 shows in more detail the form and behaviors of a unit cell geometry in the re-entrant honeycomb grid;

FIG. 9 is a schematic front face view of a spectral purity filter having auxetic portions in accordance with an embodiment of the invention;

FIG. 10 (a) illustrates a boundary between auxetic and non-auxetic grid portions, while (b) and (c) illustrate possible mixed geometries; and

FIGS. 11 and 12 illustrate alternative auxetic grid geometries available for application in a spectral purity filter according to embodiments of the invention.

### DETAILED DESCRIPTION

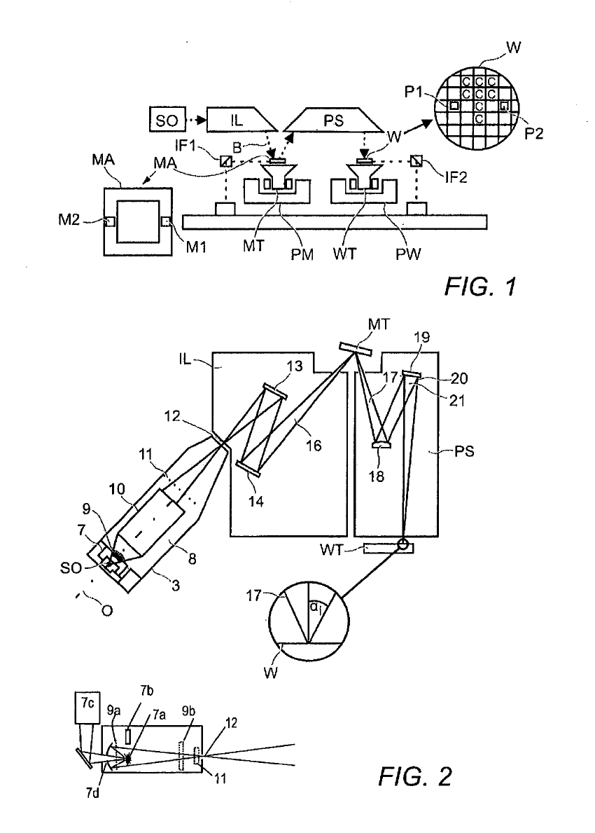

FIG. 1 depicts schematically the main features of a lithographic apparatus. The apparatus includes a radiation source SO and an illumination system (illuminator) IL configured to condition a radiation beam B (e.g. UV radiation or EUV radiation) from the source. A support MT (e.g. a mask table) is configured to support a patterning device MA (e.g. a mask or a reticle) and is connected to a first positioner PM configured to accurately position the patterning device in accordance with certain parameters. A substrate table (e.g. a wafer table) WT is configured to hold a substrate W (e.g. a resist-coated semiconductor wafer) and is connected to a second positioner PW configured to accurately position the substrate in accordance with certain parameters. A projection system PS is configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, to direct, shape, or control radiation.

The support MT supports the patterning device. It holds the patterning device in a manner that depends on the orientation of the patterning device, the design of the lithographic apparatus, and other conditions, for example whether or not the patterning device is held in a vacuum environment. The support can use mechanical, vacuum, electrostatic or other clamping techniques to hold the patterning device. The support may be a frame or a table, for example, which may be fixed or movable as required. The support may ensure that the patterning device is at a desired position, for example with respect to the projection system.

The term “patterning device” used herein should be broadly interpreted as referring to any device that can be used to impart a radiation beam with a pattern in its cross-section such as to create a pattern in a target portion of the substrate. Generally, the pattern imparted to the radiation beam will correspond to a particular functional layer in a device being created in the target portion, such as an integrated circuit. It should be noted that the pattern imparted to the radiation beam may not exactly correspond to the desired pattern in the target portion of the substrate, for example if the pattern includes phase-shifting features or so called assist features.

The patterning device may be transmissive or reflective. For practical reasons, current proposals for EUV lithography employ reflective patterning devices, as shown in FIG. 1. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of a vacuum. It may be desired to use a vacuum for EUV or electron beam radiation since other gases may absorb too much radiation or electrons. A vacuum environment may therefore be provided to the whole beam path with the aid of a vacuum wall and vacuum pumps. An example specific to EUV is described below, with reference to FIG. 2.

Any use of the term “projection lens” herein may be considered as synonymous with the more general term “projection system”. For EUV wavelengths, transmissive materials are not readily available. Therefore “lenses” for illumination and projection in an EUV system will generally be of the reflective type, that is to say, curved mirrors.

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives radiation from radiation source SO. The source and the lithographic apparatus may be separate entities, for example when the source is an excimer laser. In such cases, the source is not considered to form part of the lithographic apparatus and the radiation is passed from the source SO to the illuminator IL with the aid of a beam delivery system (not shown) including, for example, suitable directing mirrors and/or a beam expander. In other cases the source may be an integral part of the lithographic apparatus. The source SO and the illuminator IL, together with the beam delivery system if required, may be referred to as a radiation system.

The illuminator IL may include an adjusting device (adjuster) configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator and a condenser. The illuminator may be used to condition the radiation beam, to have a desired uniformity and intensity distribution in its cross-section.

The radiation beam B is incident on the patterning device MA, which is held on the support MT, and is patterned by the patterning device. After being reflected from the patterning device MA, the radiation beam B passes through the projection system PS, which focuses the beam onto a target portion C of the substrate W. With the aid of the second positioner PW and a position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 (which may also be an interferometric device, linear encoder or capacitive sensor) can be used to accurately position the patterning device MA with respect to the path of the radiation beam B, e.g. after mechanical retrieval from a mask library, or during a scan.

In general, movement of the mask support MT may be realized with the aid of a long-stroke module (coarse positioning) and a short-stroke module (fine positioning), which form part of the first positioning device PM. Similarly, movement of the substrate table WT may be realized using a long-stroke module and a short-stroke module, which form part of the second positioning device PW. In the case of a stepper, as opposed to a scanner, the support MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-) magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, a programmable patterning device MA is kept essentially stationary, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be referred to as “maskless lithography” that utilizes programmable patterning device, such as a programmable mirror array of a type as referred to above.

Combinations and/or variations on the above described modes of use or entirely different modes of use may also be employed.

FIG. 2 shows a schematic side view of a practical EUV lithographic apparatus. It will be noted that, although the physical arrangement is different to that of the apparatus shown in FIG. 1, the principle of operation is similar. The apparatus includes a source-collector-module or radiation unit 3, an illumination system IL and a projection system PS. Radiation unit 3 is provided with a radiation source SO which may employ a gas or vapor, such as for example Xe gas or a vapor of Li, Gd or Sn in which a very hot discharge plasma is created so as to emit radiation in the EUV range of the electromagnetic radiation spectrum. The discharge plasma is created by causing a partially ionized plasma of an electrical discharge to collapse onto the optical axis O. Partial pressures of, for example, 10 Pa 0.1 m bar of Xe, Li, Gd, Sn vapor or any other suitable gas or vapor may be required for efficient generation of the radiation. In an embodiment, a Sn source as EUV source is applied.

For this type of source, an example is the LPP source in which a CO₂ or other laser is directed and focused in a fuel ignition region. Some detail of this type of source is shown schematically in the lower left portion of the drawing. Ignition region 7a is supplied with plasma fuel, for example droplets of molten Sn, from a fuel delivery system 7b. The laser beam generator 7c may be a CO₂ laser having an infrared wavelength, for example 10.6 micrometers or 9.4 micrometesr. Alternatively, other suitable lasers may be used, for example having respective wavelengths in the range of 1-11 micrometers. Upon interaction with the laser beam, the fuel droplets are transferred into plasma state which may emit, for example, 6.7 nm radiation, or any other EUV radiation selected from the range of 5-20 nm. EUV is the example of concern here, though a different type of radiation may be generated in other applications. The radiation generated in the plasma is gathered by an elliptical or other suitable collector 7d to generate the source radiation beam 7e.

The radiation emitted by radiation source SO is passed from the source chamber 7 into collector chamber 8 via a contaminant trap 9 in the form of a gas barrier or “foil trap”. The purpose of this contaminant trap is to prevent or at least reduce the incidence of fuel material or by-products impinging on the elements of the optical system and degrading their performance over time. Examples of such contaminant traps are described in U.S. Pat. No. 6,614,505 and U.S. Pat. No. 6,359,969.

Returning to the main part of FIG. 2, collector chamber 8 may include a radiation collector 10 which is, for example, a grazing incidence collector comprising a nested array of so-called grazing incidence reflectors. Radiation collectors suitable for this purpose are known from the prior art. Alternatively, the apparatus can include a normal incidence collector for collecting the radiation. The beam of EUV radiation emanating from the collector 10 will have a certain angular spread, perhaps as much as 10 degrees either side of optical axis O.

Radiation passed by collector 10 transmits through a spectral purity filter 11 according to the present invention. It should be noted that in contrast to reflective grating spectral purity filters, the transmissive spectral purity filter 11 does not change the direction of the radiation beam. Examples of the filter 11 are described below.

The radiation is focused in a virtual source point 12 (i.e. an intermediate focus) from an aperture in the collection chamber 8. From chamber 8, the radiation beam 16 is reflected in illumination system IL via normal incidence reflectors 13,14 onto a reticle or mask positioned on reticle or mask table MT. A patterned beam 17 is formed which is imaged by projection system PS via reflective elements 18,19 onto wafer W mounted wafer stage or substrate table WT. More elements than shown may generally be present in the illumination system IL and projection system PS. One of the reflective elements 19 has in front of it an NA disc 20 having an aperture 21 there-through. The size of the aperture 21 determines the angle a, subtended by the patterned radiation beam 17 as it strikes the substrate table WT.

FIG. 2 shows the spectral purity filter 11 positioned downstream of the collector 10 and upstream of the virtual source point 12. In alternative embodiments, not shown, the spectral purity filters 11 may be positioned at the virtual source point 12 or at any point between the collector 10 and the virtual source point 12.

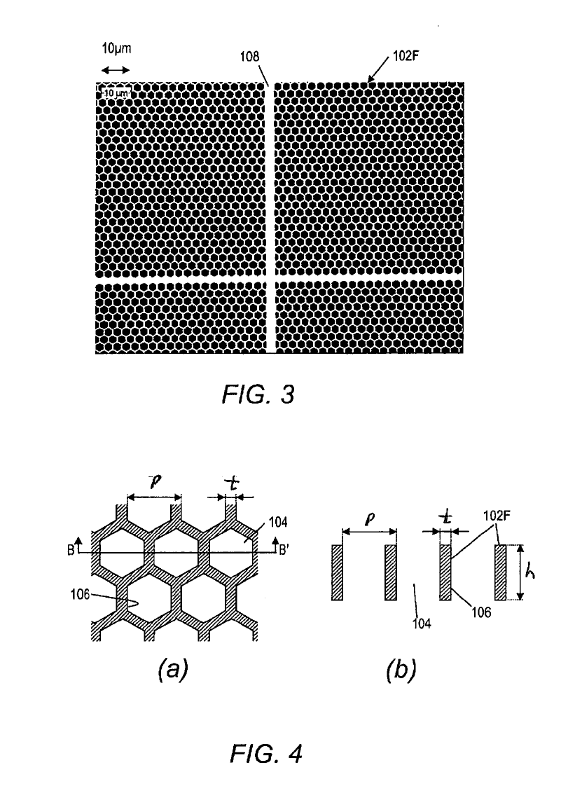

Before describing the auxetic grid portions which are subject of the present invention, the principles of the construction of a spectral purity filter grid will be described with reference to FIGS. 3 to 5, using as an example the ‘regular honeycomb’ structure. As explained above, grids embodying the present invention can include an auxetic portions side-by-side with portions having the regular honeycomb or other non-auxetic structures.

FIG. 3 is a front face view of part of a spectral purity filter part 102F made according to U.S. application No. 61/193,769 filed on 22 Dec. 2008, that may for example be applied as an element of the above-mentioned filter 11 of a lithographic apparatus. The filter part 102F is configured to transmit extreme ultraviolet (EUV) radiation while substantially blocking a second type of radiation (the ‘unwanted’ radiation) generated by a radiation source. This unwanted radiation may be, for example, infrared (IR) radiation of a wavelength larger than about 1 μm, particularly larger than about 10 μm. Particularly, the wanted EUV radiation to be transmitted and the unwanted second type of radiation (to be blocked) can emanate from the same radiation source, for example an LPP source SO of a lithographic apparatus.

FIG. 3 is a micrograph taken from a real sample, with a scale mark of 10 μm provided to assist interpretation. While the portion shown in the Figure is a fraction of a millimeter across, the entire filter part may have a dimension of several centimeters, according to the width of the radiation beam where the filter is to be applied. The filter part may be manufactured in one piece or in sections. Typical dimensions for a particular application are given in the examples below, while a similar structure may be applied in other applications, where different dimensions may be more appropriate.

FIG. 4(a) is a schematic front face view of a very small area within the filter part of FIG. 3, while FIG. 4(b) shows the same part in cross-section on line B-B′. The spectral purity filter in the examples to be described comprises a substantially planar filter part 102F (for example a filter film or filter layer). The filter part 102F has a plurality of (generally parallel) apertures 104 to transmit the extreme ultraviolet radiation and to suppress transmission of the second type of radiation. The face on which radiation impinges from the source SO will be referred to as the front face, while the face from which radiation exits to the illumination system IL can be referred to as the rear face. As is mentioned above, for example, the EUV radiation can be transmitted by the spectral purity filter without changing the direction of the radiation.

In the example shown, each aperture 104 has parallel sidewalls 106 defining the apertures 104 and extending completely from the front to the rear face. As seen in the wider view of FIG. 3, a frame structure including reinforcing ribs 108 or the like may be included in the grid part, or added to it.

Referring to the front detail view shown in FIG. 4(a), arrow t indicates a thickness t of the walls between the filter apertures 104. Arrow p indicates the period of the apertures. The thickness t can be relatively small by application of the manufacturing method described below. Arrow h indicates the height or thickness of the filter part itself Several grid SPF types can be distinguished based on different mechanisms for suppression of unwanted 10.6 μm radiation. The dimensions of the grid in accordance with embodiment of this invention may be modified according to the specifications of these filter types.

In one embodiment, EUV radiation is directly transmitted through the apertures 104, preferably utilizing a relatively thin filter 100, in order to keep the aspect ratio of the apertures low enough to allow EUV transmission with a significant angular spread. Thickness h of the filter part 102F (i.e. the length of each of the apertures 104) is for example smaller than 20 μm, for example in the range of 2-10 μm, for example the range of 5-10 μm. Also, according to a further embodiment, each of the apertures 104 may have a diameter in the range of 100 nm to 10 μm. Preferably, the apertures 104 each have diameter in the range of about 1.5-6 μm, for example the range of 2-5 μm. The thickness t of the walls between the filter apertures 104 may be smaller than 1 μm, for example in the range of about 0.2-0.6 μm, particularly about 0.5 μm. The apertures of the EUV transmissive filter 100 may have a period p in the range of about 2 to 6 μm, particularly 3 to 5 μm, for example 4 μm. Consequently, the apertures may provide an open area of about 70-80% of a total filter front surface. Advantageously, the filter 100 is configured to provide at most 5% infrared light (IR) transmission. Also, advantageously, the filter 100 is configured to transmit at least 60% of incoming EUV radiation at a normal incidence. Besides, particularly, the filter 100 can provide at least 40% of transmission of EUV radiation having an angle of incidence (with respect of a normal direction) of 10°.

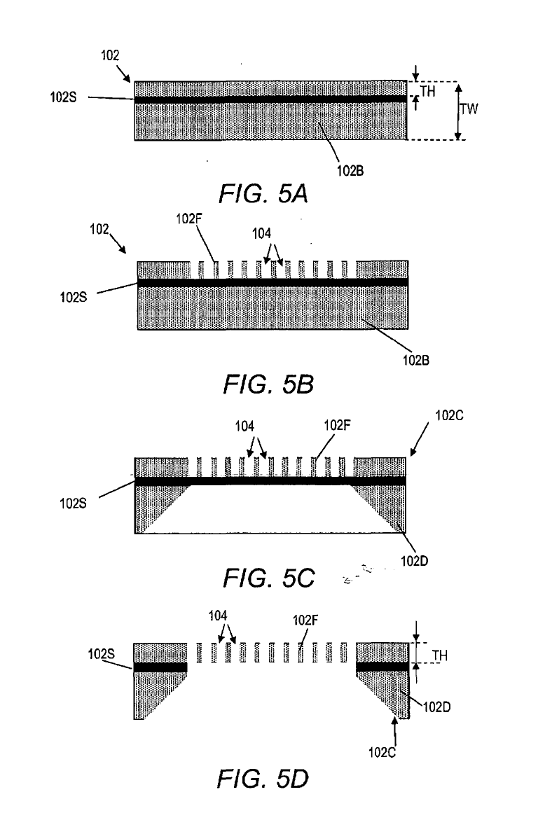

FIGS. 5A-5D show steps in an example process for manufacturing the filter part 102F. This process will be explained briefly below, while further detailed may be found in co-pending application U.S. application No. 61/193,769 filed on 22 Dec. 2008, mentioned above. For example, the grid part 102F may include a freestanding thin film of silicon (Si) and an array of apertures 104 with substantially vertical (i.e. perpendicular to the film surface) sidewalls 106. The diameter of the apertures 104 is desirably larger than about 100 nm and more desirably larger than about 1 μm in order to allow EUV radiation to pass through the spectral purity filter without substantial diffraction. In the prior application, hexagonal apertures are proposed for their combination of openness and mechanical stability. However, the manufacturing process to be described, or alternative processes, can be adapted to form other shapes of aperture and sidewalls. A wavelength to be suppressed by the filter 100 can be at least 10× the EUV wavelength to be transmitted. Particularly, the filter 100 is configured to suppress transmission of DUV radiation (having a wavelength in the range of about 100-400 nm), and/or infrared radiation having a wavelength larger than 1 μm (for example in the range of 1-11 micron).

As one example, the filter grid part 102F may be manufactured by using an anisotropic etching method, of which a suitable example the technique of deep reactive ion etching (DRIE), described briefly below. DRIE is an etching method with highly anisotropic etch rates, which enables the manufacturing of vertical etch profiles in Si using the so-called Bosch process. This is described for example in S. Tachi, K. Tsujimoto, S. Okudaira, Low-temperature reactive ion etching and microwave plasma etching of silicon, Appl. Phys. Lett. 52 (1988), 616. The Bosch process consists of alternately exposing the Si surface to an SF₆ plasma and a fluorocarbon (e.g. C₄F₈) plasma. In the first stage, silicon is etched in a more or less isotropic way, whereas in the second stage, the etched profile is covered by a passivation layer. In the next etch, this passivation layer is opened preferentially at the bottom, mainly by ion bombardment, and etching starts again. By repetition of the etch/passivation cycle, the etch proceeds layer by layer downwards into the silicon surface, without lateral spreading.

An embodiment of the filter manufacturing method comprises (i) applying a hard mask of an aperture pattern on top of a freestanding thin Si film, and (ii) deep reactive ion etching the aperture pattern vertically through the entire Si film. An alternative embodiment of the manufacturing method comprises (i) applying a hard mask of an aperture pattern on a substrate with a Si surface, (ii) deep reactive ion etching the aperture pattern vertically into the Si surface to a desired depth, and (iii) removing the part of the substrate below the etched apertures.

Referring now to FIG. 5A, the example manufacturing method begins with a planar substrate 102 of silicon. The thickness TW of the substrate 102 is much greater initially than the thickness TH desired for filter part 102F.

Starting material 102 may comprise a SOI (silicon-on-insulator) wafer, for example a (crystalline) Si wafer with an oxide layer 102S buried at a specific depth, e.g. by oxygen ion implantation. The SOI wafer 102 thus consists of a top Si layer (film) 102F, a SiO₂ intermediate layer 102S, and a bottom Si layer 102B. For example, a thickness TW of the wafer can be smaller than 1 mm, for example 670 microns.

FIG. 5B shows the result of using DRIE, by which the aperture pattern (of hexagonal apertures) is etched in the top Si layer (from a front side) that will provide the filter part 102F of thickness TH. The SiO₂ layer 102S acts as an etch stop. It will be understood that the number of apertures is far greater in the real filter than in this schematic diagram.

Subsequently, at least part of the bottom Si layer 102B extending under the aperture pattern 104 is etched away using a KOH etch. Preferably, part of the bottom layer 102B is left standing to provide a respective (lower) section of a filter holder 102C. The result is shown in FIG. 5C. Again, the SiO₂ layer may act as an etch stop.

Finally, the SiO₂ may be removed using a buffered oxide etch, the result being depicted in FIG. 5D. Also in this case, preferably, only part of the etch stop layer 102S is removed, to open up the apertures 104, wherein a remaining part of the bottom layer 102S is left standing to provide a respective section of a filter holder 102C.

As follows from FIGS. 5C-5D, preferably, the filter 100 is provided with a filter holder 102C, external to the filter part 102F having the apertures 104. For example, the filter holder 102C can be configured to surround the filter part 102F. Preferably, the filter holder 102C is substantially thicker than the (in this embodiment central) filter part 102F. For example, a thickness of the holder 102C (measured in a direction parallel to the apertures 104) can be over 20 microns, for example at least 0.1 mm.

The present filter holder 102C is an integral part of the filter 100, substantially made of filter part (semiconductor) material. For example, the filter holder 102C can be a frame 102C surrounding the filter part 102F. In the present example, the filter holder 102C still contains part of the etch stop layer (being ‘buried’ in respective substrate material), and a support part 102D that is substantially thicker than the filter part 102F. In the present example, the filter part 102F and the support layer 102D are made from the same material. In addition to the frame 102C surrounding the entire filter part 102F, it may form an intermediate frame portion such as the structural rib 108 visible in FIG. 3.

The semiconductor filter part 102F produced by the process described above can perform as a spectral purity filter without modification. In a practical embodiment, however, further processing may be applied to provide layers having specific optical and/or protective properties, to improve filter performance and longevity. These measures are described in other patent applications of the present applicant, not published at the present priority date. They do not form part of the present invention. The choice of material and manufacturing process is also not essential to the present invention. Embodiments include the filter part 102F being selected from one or more of: a semiconductor part, a crystalline semiconductor part, a doped semiconductor part, a coated semiconductor part, and an at least partly modified semiconductor part. Filter part 102F may contain at least one semiconductor material selected from Silicon, Germanium, Diamond, Gallium Arsenide, Zinc Selenide, and Zinc Sulfide. Embodiments can be made from metals, polymers and other materials besides semiconductors.

When the grid is illuminated by the source it should, ideally, reflect infrared and transmit EUV. However, a small fraction (say 10-20%) of both types of radiation will be absorbed. For commercial productivity of the lithography apparatus as a whole, a high power level is desired which will result in significant heating of the grid. Since thermal conduction is limited by the very small thickness h of the grid, variations in power density across the beam also give rise to temperature gradients over the grid area, and there will also be temperature differences between grid and the surrounding frame. Non-uniform temperatures will result in non-uniform thermal expansions. Stress and/or tension will arise in portions of the grid. To manage these forces without deformation or damage of the grid, the skilled person would naturally consider strengthening the structure. Examples of measures to achieve greater strength would be to fatten and/or deepen the sidewalls 106, fatten/deepen structural ribs 108, and/or to provide ribs 108 closer together. Unfortunately, each of these measures will increase the effective cross-section of the grid for the wanted EUV radiation, lowering its transmission undesirably. Moreover, increased absorption of both the wanted and unwanted radiation will directly increase the heating problem.

In order to provide the designer with additional freedom to resolve these conflicting requirements, the invention proposes to replace the regular honeycomb structure of the grid (or a portion of it) as shown in FIG. 4 with a modified grid geometry having a low, preferably negative Poisson's ratio. Such a re-entrant or ‘auxetic’ structure, which can be achieved by simple modification of the honeycomb geometry, is expected to be able to deal with the (differences in) expansions better than the regular honeycomb. Other auxetic structures may be applied.

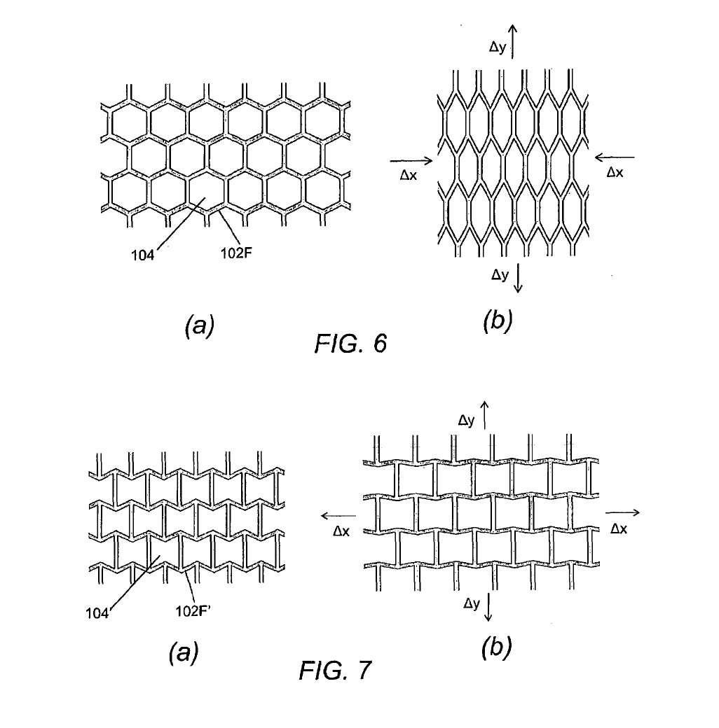

Referring to FIG. 6, the regular honeycomb structure has some very nice properties. Even though it is very open, it is quite strong. Furthermore, the regular hexagonal honeycomb may be the best way to divide a surface into regions (apertures) of equal area, while using the least total perimeter. Since the walls of the hexagons in the SPF have finite width, a low amount of perimeter, or wall, implies a high transmission for EUV.

However, the rigid compact shape of the honeycomb also implies that it is not easy for the structure to accommodate local expansions. Furthermore, like most materials, it has a positive Poisson's ratio. This means that, if it is stretched by an amount in one direction (Δy in FIG. 6(b)), it will contract (Δx) in the other direction, unless counteracted by another force. Given the symmetry of a typical optical system, it can be expected that in the SPF grid part 102F, forces will be acting in both directions simultaneously. For example a hot grid 102F surrounded by a cold frame 102C will be compressed from all sides, while a cold grid surrounded by a warmer frame will experience tensile forces from all sides. Poisson's ratio v is defined as the negative of the ratio between the axial strain and the transverse strain, when a load (compressive or tensile) is applied in the axial direction. In other words, expansion by an amount Δy will be accompanied by a transverse expansion by an amount approximately Δx=−vΔy (for a square unit cell), that is a contraction of vΔy. Strictly speaking, the Poisson's ratio formula relates the logarithmic strain ε in the axial and transverse directions, but a qualitative understanding will suffice for the present description. ‘Conventional’ materials have a positive Poisson's ratio in the range 0 to 0.5, typically 0.2-0.5.

FIG. 7 illustrates a modified grid part 102F′ having a re-entrant honeycomb structure. Each modified aperture 104′ has a bow-tie like shape, more formally a re-entrant hexagon, to form what is known as an auxetic honeycomb. This modified grid has the special property that, when extended in one direction as shown in FIG. 7(b), it will also stretch along the perpendicular direction. In other words it has a negative Poisson's ratio. Where a hot grid is constrained by a cold frame, the negative Poisson's ratio allows the forces to be distributed more evenly throughout the structure, so that stresses and tensions do not build up to the same extent as in the regular honeycomb grid. Poisson's ratio is defined to be −1 when Δx=Δy (for a square unit cell). Practical structures are likely to have a ratio approaching −1, for example in the range −0.5 to −1, but not exactly −1. For such delicate structures as are envisaged in the present application, it will be appreciated that direct measurement of Poisson's ratio may be impractical, particularly at operating temperatures, but also when lying at room temperature on a test bench. On the other hand, their structures are simple enough that their geometry and materials composition can be measured and their auxetic behavior predicted with reasonable confidence.

If local variations in temperature exist, thermal expansion will not be uniform over the entire area. If in the ordinary honeycomb a unit cell is larger than its neighbors this will result in large stresses in the ‘legs’ of the honeycomb because there is no easy way to accommodate this size difference. A small expansion of one cell may result in ‘manageable’ deformations and elastic forces, but, if a number of cells expand. these forces will build up. For example, if 10 cells each expand by just 1%, then after 10 cells the edge has shifted 10% of a unit cell. If a neighboring block of 10 cells is not experiencing the same expansion, the stress becomes rapidly very large.

FIG. 8 illustrates in detail the form and behaviors of one unit cell of the re-entrant honeycomb structure. Dashed line C indicates the outline of the rectangular unit cell in an unstressed or equilibrium state. The re-entrant honeycomb has six vertices labeled V1 to V6. Side V1-V2 has a length L. A reflex angle (that is, an angle greater than 180 degrees) is formed between the sides V6-V1 and V1-V2. An acute angle is formed between sides V1-V2 and V2-V3 and so forth, all angles summing to 720 degrees. Assuming the design has both vertical and horizontal symmetry (not necessarily the case), then the lengths of all sides and the values of all the angles can be defined by a combination of length L and one of the angles. The same shape can be expressed choosing a different pair of parameters, while shapes with less symmetry can be defined with additional parameters. Wall thickness is another important parameter, of course.

At the upper right hand side in FIG. 8, an expanded cell outline C′ is shown, in which the cell with leg length L has been stretched in one dimensions and permitted to expand freely in the other, similar to what was shown in FIG. 7(b). Without any expansion of the material, the cell has been extended in x and y directions by hinging (localized bending) of the wall material in the region of the vertices V1-V6. The acute angles have opened somewhat, while the reflex angles have closed. This combination of deflections allows the cell boundary to expand while the sum of all angles remains 720 degrees.

At bottom right in FIG. 8, another behavior is illustrated, which is significant in managing stresses caused by differential thermal expansion across the grid. Here, the individual legs of the re-entrant polygon have been lengthened substantially to a length L+ΔL, while constraining the unit cell against expansion. This is analogous to the situation where a cell is heated so that the wall material expands in length, but the grid is constrained by a frame or simply is surrounded by cells of a cooler portion of the grid. Deformation of the re-entrant polygon cell shape in this case is such that the reflex angles increase while the acute angles decrease. The double-dotted line C″ indicates that the overall size increase of the unit cell is limited compared in proportion to the expansion of the wall material, thanks to the ability of the cell to be compressed in both x and y directions simultaneously. Even when all the legs expand, the size of the unit cell does not need to increase dramatically, because of the bending at the corners of the structure. In this way a large part of the expansion can be taken up within one unit cell, and does not need to propagate through the structure. In other words, a 1% increase in leg length over a line of 10 cells no longer implies a increase in the dimension of that line of cells of 10% of a unit cell.

The behavior of a real grid of course depends on many factors: the ‘hinges’ which are simply junctions between walls in a solid material will have a limited range of operation. Design can be optimized so that a region of linear behavior, a region of maximum negative Poisson's ratio and so forth fall within the actual operating conditions where their benefit can be exploited to best effect. The reference state indicated by outline C may correspond to the grid at room temperature. Alternatively, it may be preferred to design around a reference state within or close to a nominal operating temperature, mounting conditions and so forth. The grid may be deliberately pre-stressed or tensioned, for example by thermal processing during or after manufacture, and/or by action of its mounting. The re-entrant honeycomb is not the only example of a re-entrant shape suitable to form an auxetic grid, and other examples will be mentioned below.

The auxetic grid can also be quite strong, especially in resisting shear forces. If it is deformed (bent) it prefers to form spherical shapes, as opposed to the common anti-clastic bending of the ordinary honeycomb. In a related application being filed the same day as the present application (attorney docket 081468-0382079), it is proposed to curve the grid in order to improve transmission. Specifically, where the beam is somewhat divergent, a spherical curvature can compensate so that the apertures are parallel to the wanted radiation at every position across the beam. In such an application, an auxetic grid or a grid having auxetic portions may be advantageous over the rigid, regular honeycomb.

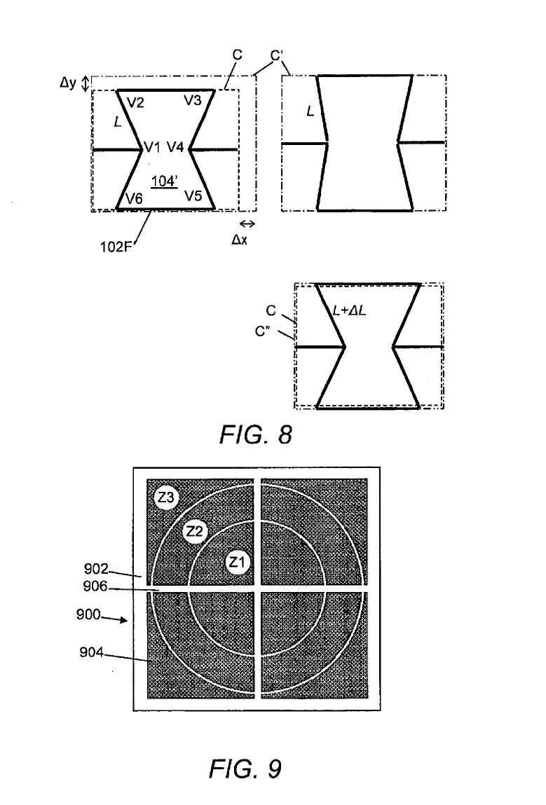

FIG. 9 is a schematic front face view of a spectral purity filter (SPF) 900 having (for example) a square form and supported by a surrounding frame 902. Within this frame, four filter grid portions 904 are defined, separated by strengthening ribs 906. In a first example, each grid portion 904 is formed entirely with an auxetic grid structure such as the re-entrant honeycomb described above. If the entire grid is hot while the surrounding frame is cold the grid would like expand, while it is being compressed by the frame. In the regular honeycomb the only way to compress the entire grid in two directions is to compress (and thus shorten) all the individual legs of the honeycomb. The re-entrant honeycomb has the additional freedom to deform the unit cell as shown in FIG. 8. This will reduce the compressive stresses in the legs of the grid cell. The legs, which are the sidewalls of the apertures in the filter grid, and also the supporting structure comprising frame 904 and ribs 906, can thus be of lighter construction that would otherwise be required to accommodate the expansion forces.

In a practical implementation of the SPF, it is not necessary to choose one type of unit cell for the entire grid area 904. Regular and re-entrant honeycombs (more generally, non-auxetic and auxetic grids) may be combined for example. In these cases it may be preferable to use a large fraction of re-entrant honeycombs at the positions where the largest temperature gradients are expected (for example at the edges, or where there are large gradients in the intensity distribution). Furthermore, the shape of the re-entrant honeycomb may be varied over the area. The angles between the legs may be varied, as well as the length of the legs, which will influence the symmetry of the cell. The wall thicknesses need not be uniform within and between the different areas.

As a simple illustration, in FIG. 9, white circles indicate three distinct zones Z1, Z2, Z3 in which different grid types may be applied. Assume that a radiation beam passing through the filter has a central, circular portion of relatively uniform intensity. In central zone Z1, a regular honeycomb grid (FIG. 6) may be deployed which will expand relatively uniformly by an amount proportional to its temperature. Outside the central region, the radiation intensity, and hence its heating effect, may fall rapidly, so that the grid material in zone Z3 expands much less than in zone Z1. An intermediate zone Z2 is therefore subject to high differential thermal expansion. The zone Z2 in this example is made of an auxetic grid such as the re-entrant honeycomb, to absorb better the forces that result. Incidentally, while the supporting structure 904, 906 is shown as a simple square ‘window frame’, this, too, can be modified to deform more readily under the differential thermal expansion. The geometry of the frame 904, 906 may reflect the smaller-scale geometry of the grid itself, for example. In a real example, the frame structure may be circular or hexagonal, to conform more closely to the circular profile of the radiation beam. Where the radiation beam has asymmetry and/or a more complex intensity distribution, or where local cooling may create additional temperature differences, the distribution of auxetic and non-auxetic zones may be more complex.

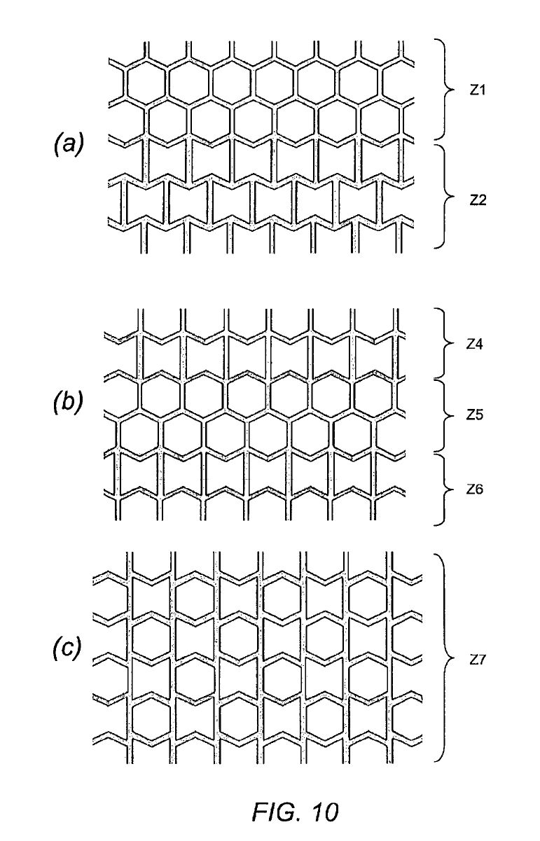

FIG. 10(a) to (c) illustrates various boundary and hybrid grid structures. In FIG. 10(a), it is seen how a regular honeycomb grid in a zone Z1 interfaces easily to a re-entrant honeycomb grid in zone Z2. These zones may for example be the circular zones in FIG. 9.

FIG. 10(b) illustrates a more intimate mixing of grid types. Two rows of regular honeycomb (Z5) are interposed between rows of re-entrant honeycomb (Z4, Z6). This structure can be repeated to obtain a hybrid of the openness of the regular hexagon and the compliant properties of the re-entrant grid. The pitch, relative number of rows of each, and their orientation, can all be varied quite freely, to achieve a range of desirable effects.

FIG. 10(c) illustrates an extremely intimate mixture of cell types in which a zone Z7 comprises regular and re-entrant hexagonal cells are mixed within the same rows. Note that this structure will be very stiff along the vertical direction (due to the straight walls in that direction), and hence not favorable in all cases. It does illustrate, however, the design freedom afforded within the concept of the invention.

Referring again to FIG. 10(a), it will be seen that the ‘bow tie’ unit cells are rotated 90 degrees in comparison with FIG. 8. In general, these cells have lower symmetry than the regular hexagon. This asymmetry, coupled with a Poisson's ratio not exactly −1, will lead to asymmetry in thermal expansion and in the management of stress and tension. To maximize symmetry in the structure as a whole, the orientation of the re-entrant cells may be varied over the grid, for example so that a certain axis of the cell is aligned generally with a thermal gradient, and another axis is aligned generally with isotherms (lines of constant temperature). In the simple example of the circular radiation beam, the temperature gradient will be expected to follow a radial direction, while the isotherms will be tangential. Where a re-entrant honeycomb grid surrounds a central regular honeycomb zone, it can be envisaged that the re-entrant cell structure will be arranged in six segments, each rotated 60 degrees relative to its neighbors. Alternatively, or in addition, sub-zones of different cell orientation can be provided within a larger auxetic portion, so that local asymmetries are compensated within the larger portion. The same considerations can be applied to the hybrid grid areas illustrated in FIGS. 10(b) and (c).

Straight walls and tessellations of hexagons are not the only forms that can be used for the auxetic grid portions. Deformation of a curved wall can serve as well as hinging at an apex, to accommodate expansion of the material without a concomitant expansion in the cell size. The invention is therefore not limited to the use of re-entrant hexagons, or re-entrant polygons in general.

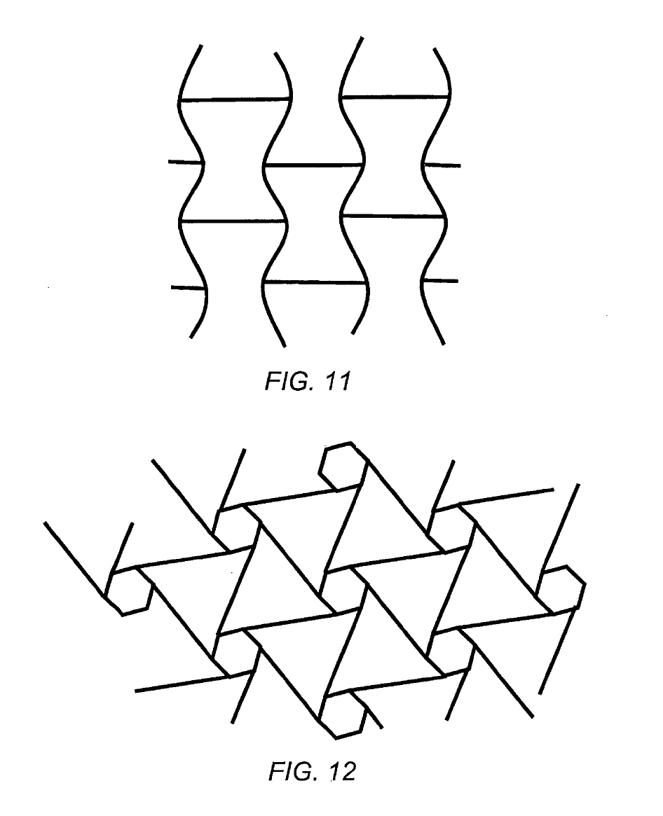

FIG. 11 illustrates a grid of re-entrant cells having two straight sides and two curved sides. The reflex angle between two straight sides is replaced by a continuous concave curvature of a single wall. The auxetic behavior in this grid may be a mixture of hinging and bending. Other workers studying auxetic structures have proposed further grid types, which may also find application in optical components such as EUV filters.

FIG. 12 shows a so-called ‘chiral honeycomb’ based on that proposed in the 1996 paper by Prall and Lakes, mentioned in the introduction. In a chiral honeycomb, the nodes of the grid structure are effectively extended and the legs of neighboring cells meet not at a point, but as tangents to a circle. (These circles are approximated by small hexagons in the illustration.) The mixture of hinging and bending which provides the auxetic property in the re-entrant honeycomb discussed above is thus augmented by an ‘unwinding’ rotation of the extended nodes relative to the larger structure. As the grid shown expands, the hexagonal nodes will rotate clockwise. As the grid contracts, they will rotate counterclockwise. The chiral honeycomb is said to offer a linearity and uniformity of properties (such as the Poisson's ratio and Young's modulus) over a wider range of expansion factors than the simpler structures. It is for the skilled reader, requiring to design a particular SPF or other microporous optical component, to decide whether the benefits of such properties justify the added complexity of these alternative grid structures in a given case. Considerations of openness, uniformity and ease of manufacture will generally favor a simpler geometry.

It will be understood that the apparatus of FIGS. 1 and 2 incorporating the spectral purity filter with silicidation resistance may be used in a lithographic manufacturing process. Such lithographic apparatus may be used in the manufacture of ICs, integrated optical systems, guidance and detection patterns for magnetic domain memories, flat-panel displays, liquid crystal displays (LCDs), thin-film magnetic heads, etc. . . . It should be appreciated that, in the context of such alternative applications, any use of the term “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The descriptions above are intended to be illustrative, not limiting. Thus, it should be appreciated that modifications may be made to the present invention as described without departing from the scope of the claims set out below.

It will be appreciated that embodiments of the invention may be used for any type of EUV source, including but not limited to a discharge produced plasma source (DPP source), or a laser produced plasma source (LPP source). However, an embodiment of the invention may be particularly suited to suppress radiation from a laser source, which typically forms part of a laser produced plasma source. This is because such a plasma source often outputs secondary radiation arising from the laser.

The spectral purity filter may be located practically anywhere in the radiation path. In an embodiment, the spectral purity filter is located in a region that receives EUV-containing radiation from the EUV radiation source and delivers the EUV radiation to a suitable downstream EUV radiation optical system, wherein the radiation from the EUV radiation source is arranged to pass through the spectral purity filter prior to entering the optical system. In an embodiment, the spectral purity filter is in the EUV radiation source. In an embodiment, the spectral purity filter is in the EUV lithographic apparatus, such as in the illumination system or in the projection system. In an embodiment, the spectral purity filter is located in a radiation path after the plasma but before the collector.

While specific embodiments of the present invention have been described above, it should be appreciated that the present invention may be practiced otherwise than as described.

1. A spectral purity filter configured to transmit extreme ultraviolet radiation, the spectral purity filter comprising a substantially planar filter part comprising an array of apertures formed between walls of a grid material, the apertures extending from a front surface to a rear surface of the filter part to transmit the extreme ultraviolet radiation incident on said front surface while suppressing transmission of a second type of radiation, wherein the apertures in an auxetic portion of said filter part are shaped and arrayed so as to confer a negative Poisson's ratio on the auxetic portion.

2. The filter according to claim 1, wherein the Poisson's ratio in said auxetic portion is less than zero or even less than −0.5.

3. The filter according to claim 1, wherein said filter part comprises at least one non-auxetic portion having a Poisson's ratio greater than 0.1, in addition to said auxetic portion.

4. The filter according to claim 3, wherein the at least one non-auxetic portion is surrounded by the auxetic portion or an array of auxetic portions.

5. The filter according to claim 3, wherein the at least one non-auxetic portion comprises apertures of regular hexagonal shape.

6. The filter according to claim 1, wherein the auxetic portion comprises apertures of re-entrant hexagonal shape.

7. The filter according to claim 1, wherein the auxetic portion comprises apertures of re-entrant polygonal shape.

8. The filter according to claim 1, wherein the filter part comprises a plurality of auxetic portions, and wherein different auxetic portions have different geometries, when viewed in a non-operational state.

9. The filter according to claim 1, wherein a plurality of auxetic portions are interposed between a plurality of non-auxetic portions.

10. The filter according to claim 1, wherein said filter part is provided with a surrounding frame structure, the auxetic portion in use compensating for different thermal expansions between said frame structure and operating portions of the filter.

11. A lithographic apparatus comprising:
a radiation source configured to generate radiation comprising extreme ultraviolet radiation;
a illumination system configured to condition the radiation into a beam of radiation;
a support configured to support a patterning device, the patterning device being configured to pattern the beam of radiation;
a projection system configured to project a patterned beam of radiation onto a target material; and
a spectral purity filter configured to transmit extreme ultraviolet radiation, the spectral purity filter comprising a substantially planar filter part comprising an array of apertures formed between walls of a grid material, the apertures extending from a front surface to a rear surface of the filter part to transmit the extreme ultraviolet radiation incident on said front surface while suppressing transmission of a second type of radiation., wherein the apertures in an auxetic portion of said filter part are shaped and arrayed so as to confer a negative Poisson's ratio on the auxetic portion.

12. An apparatus according to claim 11, wherein said radiation source comprises a fuel delivery system and laser radiation source, the laser radiation source Being arranged to deliver radiation at infrared wavelength onto a target comprising plasma fuel material delivered by said fuel delivery system for the generation of said extreme ultraviolet radiation, the radiation source thereby emitting a mixture of extreme ultraviolet and infrared radiation toward said spectral purity filter.

13. A method for manufacturing a transmissive spectral purity filter, configured to transmit extreme ultraviolet radiation, the method comprising etching a plurality of apertures in a substrate of carrier material using an anisotropic etching process to form a grid-like filter part, said apertures having a diameter much greater than a wavelength of said extreme ultraviolet radiation while being smaller than or comparable to a wavelength of second radiation to be suppressed, wherein the apertures in an auxetic portion of said filter part are shaped and arrayed so as to confer a negative Poisson's ratio on the auxetic portion, at least when under operating conditions.

14. The method according to claim 13, wherein said apertures in said auxetic portion each have the form of a re-entrant hexagon.

15. The method according to claim 13, wherein the substrate of carrier material comprises a semiconductor substrate having an etch stop layer, and wherein the method further comprises
etching through the semiconductor substrate using the anisotropic etching process so that the apertures reach the etch stop layer; and
subsequently removing the etch stop layer.
